(19) United States
(12) Patent Application Publication
(10) Pub. No.: US 2017/0312899 A1
(43) Pub. Date: Nov. 2, 2017

(54) A POWER CONTROL DEVICE FOR A PNEUMATIC IMPULSE WRENCH

(71) Applicant: ATLAS COPCO INDUSTRIAL TECHNIQUE AB, Stockholm (SE)

(72) Inventors: Rolf Ulrik JANSSON, Tierp (SE); Per Thomas SÖDERLUND, Värmdö (SE)

(73) Assignee: ATLAS COPCO INDUSTRIAL TECHNIQUE AB, Stockholm (SE)

(21) Appl. No.: 15/517,816

(22) PCT Filed: Oct. 8, 2015
(86) PCT No.: PCT/EP2015/073252

§ 371 Date: Apr. 7, 2017

(30) Foreign Application Priority Data
Oct. 9, 2014 (SE) 1451206-5

(51) Int. Cl. B25B 23/145; B25B 21/02; B25B 23/14; B25B 23/00; B25B 21/00

(52) U.S. Cl. CPC B25B 23/1453; B25B 21/02; B25B 23/14; B25B 21/00; B25B 23/00

(57) ABSTRACT

A pneumatic impulse wrench includes a motor, a housing with a pressure air inlet passage, an exhaust air outlet passage, and an air flow control valve provided in the exhaust air outlet passage and including a valve element shiftable between an exhaust air flow restricting position and an exhaust air flow non-restricting position. A rigid contact member is provided to positively define the exhaust air flow restricting position of the valve element, and a bypass passage of a well-defined flow area is provided to let through a limited exhaust air flow as the valve element occupies the flow restricting position in engagement with the contact member.

The invention relates to a power control device for a pneumatic impulse wrench.

In particular the invention concerns a power control device for a pneumatic impulse wrench comprising an exhaust air control valve provided in the exhaust air passage of the impulse wrench and intended to control the power output of the impulse wrench motor in response to the actual torque resistance experienced from a screw joint being tightened.

As described in for instance U.S. Pat. No. 6,135,213 and EP patent application 09746843.3 there is a problem concerned with pneumatically powered impulse wrenches, namely the risk for reaching an installed torque level in a screw joint being tightened that exceeds the desired tightening target level at the very first delivered impulse. The reason is that during the pre-seating threading down phase of a tightening process the torque resistance in the screw joint is low and the rotation speed of the wrench motor accelerates to a very high level, and when tightening a stiff screw joint, i.e. a screw joint with a steep torque growth, the inertia energy gathered in the rotating parts of the wrench may be high enough to cause an overtightening of the screw joint at the very first delivered torque impulse already.

So, to avoid a screw joint being tightened to a level beyond the desired tightening target level at the very first delivered torque impulse there is provided an exhaust air control valve arranged to restrict the exhaust air flow from the wrench motor and thereby the motor speed during the initial low torque stage of the tightening process. The purpose is to avoid building-up of a too high inertia energy in the rotating parts of the wrench before the very first delivered impulse.

A problem with prior art exhaust control valves of this type, however, is the difficulty to obtain an exact exhaust air flow that is required for obtaining a well controlled rotation speed of the power wrench during the initial low torque phase of a screw joint tightening process. In those known motor speed control arrangements the motor speed of the impulse wrench is determined by a reduced opening of the exhaust control valve corresponding to the actual counter pressure in the pressure feed passage to the wrench motor. However, this reduced opening of the valve and the consequent grade of exhaust air flow through the outlet passage is dependent on a clearance and tolerance related flow passage formed past the valve. In other words, the exhaust air flow area past the exhaust control valve at low torque load is dependent on dimensional variations of the adjoining parts of the valve, i.e. the clearance between the valve element and its guiding surfaces as well as between the contact surfaces of the seat and the valve element. It also means that an individual adjustment of each impulse wrench has been necessary to obtain a desired low torque speed level, which has caused unnecessary extra costs.

One method for accomplishing a better control of the exhaust air flow and the rotation speed at low torque condition would be to increase the accuracy of exhaust control valve parts. However, increasing accuracy in manufacturing processes to bring down dimensional variations is rather expensive and undesirable.

It is an object of the invention is to provide a power control device for a pneumatic impulse wrench comprising an exhaust air flow control valve providing an improved control of the exhaust air flow as well as the low torque speed of the wrench motor.

It is another object of the invention to provide an exhaust air control valve for a pneumatic impulse wrench wherein an exact grade of the exhaust air flow is obtained during low torque conditions of the impulse wrench without involving costly increases in tolerance accuracy of the adjoining valve parts and/or time consuming individual adjustments of each delivered impulse wrench.

Further objects and advantages of the invention will appear from the following specification and claims.

A preferred embodiment of the invention is described below with reference to the accompanying drawing.

In the drawing

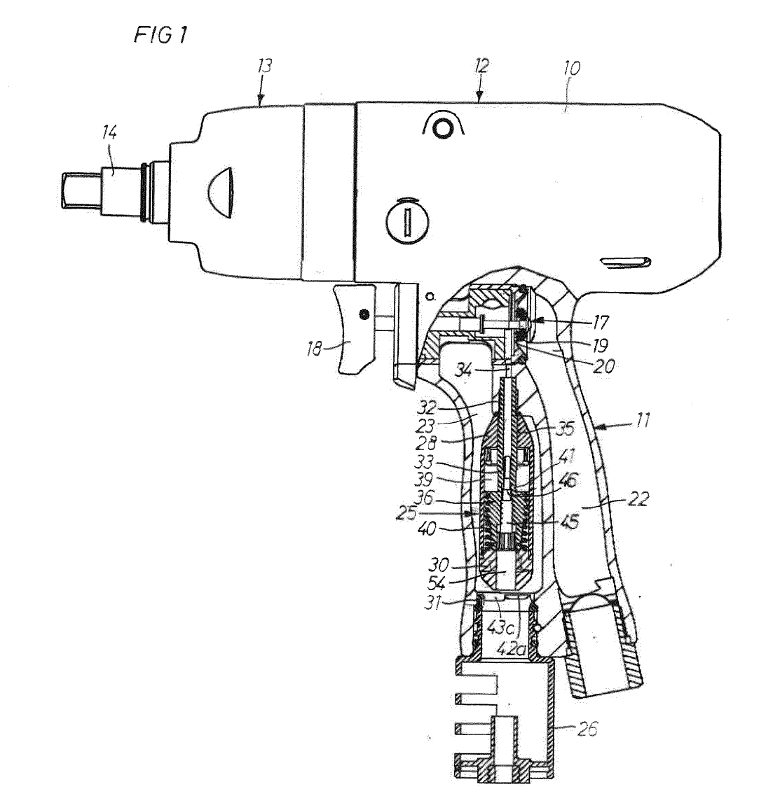

FIG. 1 shows a side view, partly in section, of a pneumatic impulse wrench according to the invention with an exhaust air control valve illustrated in fully open position.

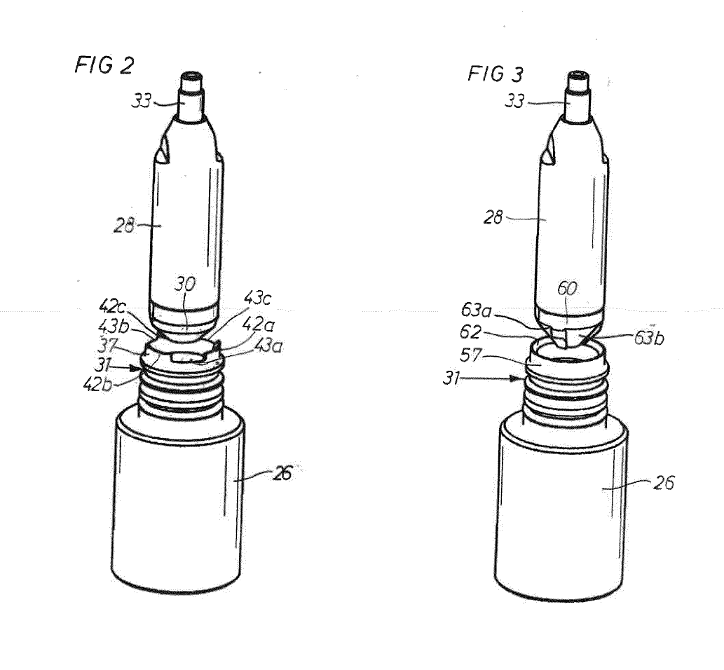

FIG. 2 shows on a larger scale a perspective view of the exhaust air flow control valve of the impulse wrench in FIG. 1.

FIG. 3 shows on a larger scale a perspective view of an exhaust air flow control valve according to an alternative embodiment of the invention.

The impulse wrench illustrated in the drawings comprises a housing 10 with a handle 11, a pneumatic motor 12, an impulse unit 13, and an output shaft 14 for connection to a screw joint to be tightened. The motor 12 and the impulse unit 13 are of conventional types and do not form any part of the invention and are, therefore, not described in further detail.

At the upper part of the handle 11 there is provided a throttle valve 17 to be maneuvered by a trigger 18 and comprises a movable valve element 19, and a valve seat 20. The handle 11 also comprises an inlet passage 22 for pressure air supply to the motor 10 via the throttle valve 17, and an exhaust air output passage 23. The latter is provided with an exhaust air flow control valve 25 and an outlet deflector 26.

The exhaust air flow control valve 25 comprises a movable casing 28 which is carrying at its lower end a somewhat conical valve element 30 arranged to cooperate with a stationary valve seat 31 mounted in the outlet passage 23. A control flow tube 33 is fixed to the housing 10 via a thread connection 32 and communicates with the pressure air inlet passage 22 downstream of the throttle valve seat 20 via a control flow passage 34. The control flow tube 33 extends into the casing 28 via a reduced diameter portion 35 of the casing 28 and forms a guide for the rectilinear movement of the latter. At its lower end the control flow tube 33 carries a piston 36 which is arranged to operate in an activation cylinder 39 formed inside the casing 28. The piston 36 forms a support for a spring 40 which acts on the valve element 30 to thereby bias the latter as well as the casing 28 towards the valve seat 31.

Adjacent the piston 36 the control flow tube 33 is provided with a lateral opening 41 for connecting the inside of the control flow tube 33 with the activation cylinder 39 to thereby open up an air flow communication between the pressure air inlet passage 22 and the activation cylinder 39. Inside the piston 36 there is provided an adjustment screw 45 which extends into the control flow tube 33 and having a shoulder 46 by which the air flow through the lateral opening 41 may be set to obtain a desirable movement pattern of the valve element 30 and, thereby, a favorable opening characteristic of the flow control valve 25. The adjustment screw 43 is accessible from outside via a central aperture 54 in the valve element 30 which also has the purpose of prevent pressure build-up at the upper end of the valve element 30.

As clearly illustrated in FIG. 2, the valve seat 31 is formed with a tubular socket portion 37 with a contact surface divided into three sections 42a,b,c for sealing engagement with the valve element 30 in the air flow restricting position of the latter. Between the contact surface sections 42a,b,c there are three apertures 43a,b,c, which together form a bypass passage for letting through exhaust air in an exhaust air restricting position of the valve element 30. In this position the valve element 30 is in a firm and sealing engagement with the contact surface sections 42a,b,c leaving the three apertures 43a,b,c open for the exhaust air flow.

In operation of the impulse wrench the pressure inlet passage 22 is connected to a pressure air source and the output shaft 14 is connected to a screw joint to be tightened via suitable nut socket. A screw joint tightening process is commenced by the operator pressing the trigger 18 to initiating a pressure air flow to the motor 12, and in most cases the torque resistance from the screw joint is very low in the initial running down stage of the process. This means that the motor accelerates quickly to a high speed level which means that the motor rotor together with impulse unit reach a rather high speed before the actual pre-tensioning of the screw joint begins. This high kinetic energy built-up in the rotating parts would accomplish an undesirably intense first torque impulse, which in case of a stiff screw joint might cause an installed torque magnitude in the screw joint that exceeds the desired target torque level.

Due to the initial low back pressure from the motor 12 during the low load stage of the process the air pressure in the inlet passage 22 downstream of the throttle valve 19 the pressure in the control passage 34 is low as is the pressure in the activation cylinder 39. This means that the force of the spring 40 will dominate over the force acting on the casing 28, and that the valve element 30 will be kept in firm sealing engagement with the contact surface sections 42 a,b,c of the socket portion 37. The exhaust air flow area is thereby limited to the bypass passage formed by the three apertures 43a,b,c. These constitute a well defined flow area which is not dependent on any uncertain initial movement of the valve element 30.

After the first torque impulse has been delivered to the screw joint at a power limited by a restricted exhaust air flow from the motor and the torque resistance from the screw joint has increased considerably the back pressure from the motor 12 in the inlet passage 22 downstream of the throttle valve 19 has increased as well. This means that pressure in the control passage 34 and the activation cylinder 39 has increased as well, whereby the activation force on the casing 28 exceeds the force of the spring 40 such that the casing 28 together with the valve element 30 will be displaced away from the seat 31. The result is an increased flow area for the exhaust air and a decreased power limitation of the motor. The higher the torque resistance from the screw joint the less limitation of the motor power, i.e. the motor can operate at maximum power to the end of the tightening process. The exhaust air control valve 25 now occupies its fully open position, as illustrated in FIG. 1.

By the adjustment screw 45 the control air flow to the activation cylinder 39 through the lateral opening 41 may be set to accomplish a desirable response of the valve displacement in relation to the pressure changes in the inlet passage 22.

In the alternative embodiment of the invention illustrated in FIG. 3 the valve seat 31 has a tubular socket portion 57. The latter has a circular contact surface 62 to be engaged by the valve element 60 in the exhaust air restricting position. The restricted exhaust air flow is controlled by a bypass passage of a well defined flow area which is materialized by a number of apertures 63 a,b formed on the valve element 60. This means that when the valve element 60 occupies its flow restricting position in contact with the tubular socket portion 57 of the valve seat 31 the bypass passage is formed by the apertures 63 a,b in cooperation with the contact surface 62.

It is to be understood that the embodiments of the invention are not limited to the two described example but may be freely varied within the scope of the claims. Accordingly, the bypass passage may be formed in a different ways other than the apertures 43a,b,c in the valve seat 31 or the apertures 63 a,b formed on the valve element 60. The essential thing is that the valve element 30 has a fixed flow restricting position and that the bypass passage is independent of any initial movement of the valve element 30 during the initial stage of the tightening process. That guarantees a well defined power reduction of the wrench motor during the low load stage of a tightening process and that the risk for overtightening a stiff screw joint at the very first delivered torque impulse is minimized.

The operation of the exhaust air flow control valve may be governed in different ways, for instance by the actual pressure, i.e. the back pressure from the motor, in the pressure air inlet passage as described above or by an electrical signal received from an operation control unit and representing the actual torque resistance from the screw joint. In this case the air operated activation cylinder 39 is exchanged by an electro-mechanical device for displacing the valve element in accordance with the electrical signal. The signal representing the actual torque resistance applied on the motor may be retrieved from the actual motor current.

1-5. (canceled)

6. A pneumatic impulse wrench comprising a motor, a housing with a pressure air inlet passage, an exhaust air outlet passage, and an air flow control valve provided in the exhaust air outlet passage and including a valve element shiftable between an exhaust air flow restricting position and an exhaust air flow non-restricting position,
wherein a rigid contact member is provided to positively define the exhaust air flow restricting position of the valve element, and a bypass passage of a well-defined flow area is provided to let through a limited exhaust air flow as the valve element occupies the flow restricting position in engagement with the contact member.

7. The pneumatic impulse wrench according to claim 6, wherein the contact member is formed as a valve seat which is provided with at least one aperture forming the bypass passage.

8. The pneumatic impulse wrench according to claim 7, wherein the valve seat is formed with a tubular socket portion provided with the at least one aperture.

9. The pneumatic impulse wrench according to claim 6, wherein the contact member is formed with a circular contact surface to be engaged by the valve element in the flow restricting position, and the bypass passage is formed by at least one aperture in the valve element.

10. The pneumatic impulse wrench according to claim 6, wherein the air flow control valve is provided with an air pressure responsive activating device, and a control pressure line is provided between the pressure air inlet passage and the activating device, wherein the activating device is arranged to start shifting the valve element away from the exhaust air flow restricting position at pressure magnitudes in the air inlet passage exceeding a certain level.

11. The pneumatic impulse wrench according to claim 7, wherein the air flow control valve is provided with an air pressure responsive activating device, and a control pressure line is provided between the pressure air inlet passage and the activating device, wherein the activating device is arranged to start shifting the valve element away from the exhaust air flow restricting position at pressure magnitudes in the air inlet passage exceeding a certain level.

12. The pneumatic impulse wrench according to claim 8, wherein the air flow control valve is provided with an air pressure responsive activating device, and a control pressure line is provided between the pressure air inlet passage and the activating device, wherein the activating device is arranged to start shifting the valve element away from the exhaust air flow restricting position at pressure magnitudes in the air inlet passage exceeding a certain level.

13. The pneumatic impulse wrench according to claim 9, wherein the air flow control valve is provided with an air pressure responsive activating device, and a control pressure line is provided between the pressure air inlet passage and the activating device, wherein the activating device is arranged to start shifting the valve element away from the exhaust air flow restricting position at pressure magnitudes in the air inlet passage exceeding a certain level.
